(19) United States
(12) Patent Application Publication
(10) Pub. No.: US 2026/0316483 A1
(43) Pub. Date: Oct. 15, 2026

(54) OPTICALLY VARIABLE SECURITY ELEMENT, VALUE DOCUMENT AND PRODUCTION METHOD

(71) Applicant: Giesecke+Devrient Currency Technology GmbH, Munchen (DE)

(72) Inventors: Hans LOCHBIHLER, Munchen (DE); Thomas GERHARDT, Gmund am Tegernsee (DE); Matthias PFEIFFER, Munchen (DE)

(21) Appl. No.: 19/542,943

(22) Filed: Feb. 18, 2026

(30) Foreign Application Priority Data
Feb. 20, 2025 (DE) 102025106385.0

(51) Int. Cl. B42D 25/45; B42D 25/355; B42D 25/36

(52) U.S. Cl. CPC B42D 25/45; B42D 25/355; B42D 25/36

(57) ABSTRACT

An optically variable security element is disclosed for the securement of security papers, value documents and other value articles, which comprises: a substrate body having a front side and a rear side, a dielectric layer which is applied to the front side of the substrate body and comprises a microfacet arrangement comprising first micromirror facets and second, different micromirror facets, and a reflective layer which is applied to the microfacet arrangement and thus forms the micromirror arrangement. The first micromirror facets have a smooth surface shape or a curved, focusing surface shape, and the second micromirror facets have a curved surface shape that has no focusing effect.

### BACKGROUND

The invention relates to an optically variable security element for securing security papers, value documents and other value articles, which comprises a substrate body having a front side and a back side, a dielectric layer applied to the front side of the substrate body and comprising a microfacet arrangement comprising first micromirror facets and second micromirror facets, and a reflective layer, which is applied to the microfacet arrangement and thus forms a micromirror arrangement.

For their securement, value documents are often provided with security elements having micromirror arrangements, which permit verification of the authenticity of the value document and at the same time increase the anticounterfeit security, since they cannot be reproduced even with the most modern photocopiers. Such micromirror arrangements are described in EP 2 507 069 B1, for example. They are particularly suitable for forming motifs that appear three-dimensional to a viewer. This is especially the case for Fresnel structures, with which arched surfaces can be replicated. It is also possible here to arrange the micromirrors such that the motif additionally exhibits movement effects on tilting or turning.

It is known, moreover, that the motifs can be given colored configurations. This is achieved by coating a surface of the micromirrors with a multilayer coating or by superimposing color-imparting nanostructures on the micromirrors. These nanostructures may be coated either with a single metal layer or with a multilayer coating. The regions in which the color-imparting nanostructures are provided have a glossy effect, since the incident light is reflected at the electron gas of the smooth surface and therefore undergoes hardly any scattering. A specular reflection also occurs with embossed subwavelength structures located on a planar surface. Pigment colors, on the other hand, show a wide scattering of the reflected light and appear matt. It is known practice to describe the scattering and absorption properties of pigmented systems by way of the Kubelka-Munk theory.

It is likewise known practice to produce motifs with metallic gloss by conventional printing methods, specifically by using metal effect pigments in inks. The printing of glossy metal effect pigments can of course, as is known, be combined with the printing of matted pigment colors. However, such printing methods, and especially their combination, are limited in terms of spatial resolution. Furthermore, combining the two conventional printing methods does not enable production of matt-gloss motifs which develop a movement effect on tilting or turning.

### SUMMARY

It is an object underlying the invention to specify a security element of the generic kind that avoids the disadvantages of the prior art and that in particular increases the anticounterfeit security and at the same time is easy to manufacture in high volume, while being very costly and complicated for a counterfeiter to reproduce. A corresponding value document and a method for producing the security element are also to be provided.

An optically variable security element is provided for safeguarding of security papers, documents of value and other articles of value. The security element has a substrate body that has a front side and a reverse side. Substrate bodies used may be polymer substrates, for example PET substrates, paper substrates, or combined paper and polymer substrates.

A dielectric layer is applied to the front side of the substrate body, and comprises a microfacet arrangement as a structure for a micromirror arrangement. Preferably, the dielectric layer is provided by embossing an embossing varnish with the desired microfacet arrangement. The embossing varnish may be transparent or chromatically translucent or colored. The microfacet arrangement comprises first micromirror facets and second, different micromirror facets, which are each individually not perceptible with the naked eye. The lateral extent of a micromirror facet is less than 50 μm, and so individual micromirror facets of a motif cannot be resolved by the unassisted eye of a viewer. They are larger than 2 μm, however, in order to diminish light diffraction at the boundary of the micromirror facets. More preferably, a micromirror facet has a lateral extent of 3 μm to 10 μm. The first micromirror facets have a smooth surface shape or a curved, focusing surface shape. More preferably, the first micromirror facets have a concavely curved surface shape, and so the reflected light is concentrated at a distance of 20 cm to 50 cm. This distance corresponds to a typical viewing situation. The focus of the first micromirror facets is thus exactly in the plane of a viewer. The second micromirror facets have a curved surface shape, which at this distance has a light-scattering rather than a focusing effect. For the purposes of this patent application, the term “focusing” is used when light rays incident in parallel are bundled in a focal point. The glossy or matted appearance is a result of the scatter distribution of the reflected light component. The gloss of a surface can be quantified by the ratio of the directed to the diffusely reflected components. Essentially, surfaces which have a mean scattering angle breadth of less than 5° appear to a viewer to be glossy. Surfaces with larger mean scattering angle breadths, on the other hand, appear matted.

A reflective layer is applied to the microfacet arrangement in the dielectric layer, and so together they form the micromirror arrangement. A preferred arrangement of micromirror facets in the microfacet arrangement is a Fresnel structure. After coating with the reflective layer, the micromirror arrangement preferably also has the form of a Fresnel structure.

With the micromirror arrangement, motifs can be generated that have glossy regions and matted regions in combination, and that additionally exhibit an arching or movement effect. This is achieved by the fact that on the one hand the arching or movement effect is generated by the micromirror arrangement and on the other hand, due to a variation in the planarity of the surface shape between first and second micromirror facets, glossy regions and matted regions are generated. In the glossy regions, the surface shape of the first micromirror facets is smooth or slightly curved, and so it has a focusing effect at a distance of 20 cm to 50 cm, i.e., in the viewer plane. In the matted regions, the surface shape of the second micromirror facets is curved, but has no focusing effect at the distance of the viewer plane. The curved surface shape of the second micromirror facets ensures that the incident light rays are scattered. In one preferred version, the matted regions and the glossy regions are directly adjacent to one another or are interspersed in one another.

With the unassisted eye, a viewer perceives a surface as metallically glossy when the scattered component of the incident light is low and the light is reflected at the surface at a narrow spatial angle with relatively high intensity. Light scattering at a large spatial angle, on the other hand, makes a surface appear matted. Glossy regions of a motif are generated by the first micromirror facets, whose surface shape is smooth or slightly concavely curved, and so high light concentration of the reflected light component occurs at the distance of a viewer. Matted regions of a motif are generated by the second micromirror facets, whose surface shape is curved but does not have a focusing effect and thus the incident light is scattered.

This scattering effect and thus the matt appearance of the matted regions results both from a concave and from a convex curvature of the surface of the second micromirror facets. The curvature of the surface of the second micromirror facets may preferably be spherical or parabolic. The focus of a ball-shaped sphere is given by f=r/2, where r is the radius of the sphere. A deflection h in the middle of the circle segment with the length s can be estimated as follows:

h=s/2*tan(1/2 arcsin(s/4/f))≈s²/16/f
where the segment height is h, the chord is s and the focus is f.

In certain embodiments, the curved surface shape of the second micromirror facets may vary laterally along their surface. It is possible, for example, for the curvature to run laterally along the surface of the second micromirror facets initially in a concave way, but then to transition into a convex curvature (concave-convex)—the reverse case (convex-concave) is of course equally possible. The second micromirror facets in that case have a surface shape with at least one elevation and/or at least one depression.

A uniformly curved surface shape of the second micromirror facets results in a homogeneous scatter distribution of the light rays within limiting angles which are defined by a maximum inclination angle relative to the averaged mirror plane. By variation of the curvature laterally along the surface of the second micromirror facets, i.e., if the surface shape of the second micromirror facets has at least one elevation and/or depression, a scatter distribution with a maximum and decreasing intensity in the direction of the limiting angles can be generated.

The surface shape of the second micromirror facets may also have unilaterally declining slope lines in three-dimensional space, looking at their vertical profile—the surface of the second micromirror facets is in that case tilted or arched in both spatial directions of a plane.

Furthermore, the surface shape of the second micromirror facets may have a slope line in the vertical profile that runs toward an extreme point in the center or runs away from said point. The surface is then, for example, curved in both spatial directions of a plane, and so it is also possible, for example, that the second micromirror facets are formed as a collimator. Such a shape promotes a high intensity component in the glossy regions of a motif. The surface shape of the second micromirror facets can then be rotationally symmetrical, for example.

Preferably, the surface shape of the second micromirror facets can have slope lines in the vertical profile that run away from at least two extreme points at the edges. These are surface curvatures of the second micromirror facets that are not rotationally symmetrical to the face center, such as a surface in saddle shape, which is curved concavely in one spatial direction and convexly in the other spatial direction. Surfaces with a plural symmetry and a declivity in the center are also possible. Such irregular shapes of the surface of the second micromirror facets can have a focusing effect in certain spatial directions and a scattering effect in other spatial directions. This means that an external viewer may see a motif as either a glossy or a matted region, depending on the azimuth angle. With the second micromirror facets, therefore, at certain azimuth angles, as with the first micromirror facets, a glossy region may therefore be generated which then appears matted at a different azimuth angle.

The arching of the surface of the second micromirror facets determines the scatter distribution of the light. A uniform curvature results in a homogeneous scatter distribution within the limit angles that is dictated by the maximum inclination of the surface relative to the mirror plane. The curved surface of a collimator causes a strong concentration of the reflected light in the direction of an external viewer, who perceives these regions as metallically glossy. A motif region is perceived as matted when the surface has a light-scattering effect. Metallically glossy surfaces are notable for a relatively high light intensity in reflection and for a low scattering in the angular distribution thereof. Conversely, the incident light is strongly scattered in an angular range by matted surfaces. Particularly preferred is a full width at half maximum for the scatter distribution of the matted region of greater than 5°, preferably greater than 10°.

It is also possible to structure the surface of the first micromirror facets and/or the second micromirror facets to generate a matt appearance. One example of structuring may be the provision of a structure having a multiplicity of elevations and depressions, a random structure for example, on the surface of the micromirror facets.

The micromirror arrangement is generated by means of embossing in the dielectric layer. It is thus possible to generate matt-gloss effects, including in combination with color effects, with positional accuracy, since the embossing method for generating the optical effect has a much higher positional accuracy than known printing methods. In addition, it is possible by means of an embossing method to generate matt-gloss effects which additionally have an arching or movement effect that results from the micromirror arrangement. The matt-gloss effects can also have colors and alter them when the security element is tilted/turned, for example by the application of a color shift coating. This type of micromirror arrangements thus increases the anticounterfeit security of value documents, while ensuring that they can be produced cost-effectively at high volume.

The reflective layer of the micromirror arrangement can be a metallization or a high-refractive-index coating. The metallization may comprise Al, Ag, Au, Ni, Fe, Cu, W, Cr and/or alloys of these metals. The high-refractive-index layer may comprise, for example, ZnS, ZnO, Ta₂O₅, TiO₂ or organic materials or nanocomposites. It is equally possible that the reflective layer is a multilayer coating, for example a color shift coating. Such color shift coatings have a semi-transparent metal layer, a metallic mirror layer underneath, and an intermediate dielectric spacer layer. This layer construction causes only a part of the incident light spectrum to be reflected and thus the reflection of white light (sunlight) appears colored to the external viewer. The hue here depends on the angle of incidence of the light rays. Due to its multilayer construction, a color shift coating offers the viewer a different-colored perceived image at different viewing angles and shows, for example, a different perceived color or brightness depending on the viewing angle. This allows an additional color and/or brightness effect to be generated when the security element is tilted, which further increases the anticounterfeit security.

In embodiments, the dielectric spacer layer comprises SiO₂, MgF₂, Ta₂O₅, TiO₂, Al₂O₃, MgO, HfO₂, ZnO, ZnS and/or transparent organic materials. The same materials can of course equally be used for the abovementioned dielectric layer.

In embodiments, the micromirror arrangement or the microfacet arrangement may have a color-imparting nanostructure superimposed on it. The overall structure comprising color-imparting nanostructure and microfacet arrangement or micromirror arrangement is coated either with a single metal coating or with a multilayer. The color-imparting nanostructures may be one-dimensionally periodic or two-dimensionally periodic. In particular, the first micromirror facets and the second micromirror facets may have different color-imparting nanostructures superimposed thereon, by their lattice parameters being chosen to be different. This increases the anticounterfeit security to a particular extent, as in addition to a matt-gloss effect and a movement effect, there is also a color switch between the regions.

In a further embodiment, the dielectric layer may have a translucent coloration. It is equally possible that the security element is overprinted over the full area or regionally on one side with one or more translucent colors.

The micromirror arrangements described are preferably suitable for the colored configuration of security features for value documents, such as banknotes, ID cards, or cards for payment transactions. With the aid of these micromirror arrangements, for example, motifs can be replicated which additionally have a three-dimensional appearance and/or have a color shift effect. They are particularly suitable as human features that are visible to an external viewer with the unassisted eye. They can be arranged side by side with known structures such as holograms, color-imparting nanostructures, motheye structures, microcavities, and microlens arrays. In particular, they can be directly adjacent to such structures, since the micromirror arrangements described are introduced into the dielectric layer by means of embossing and thus are generated with very high positional accuracy—a substantially higher positional accuracy is achieved than with known printing methods. In addition, a plurality of different embossing structures and thus a plurality of different security features can be generated in a single embossing step, which considerably reduces the production effort and, in association therewith, the production costs for the security element.

More preferably, the optically variable security element is a foil security element, for instance a security thread, a security tape or a security patch. It can then be applied without difficulty as transfer element to a document of value. The foil security element can equally be equipped with further functional layers, e.g., a machine-readable magnetic coding, a UV luminescence, a phosphorescence, an infrared coding, or similar.

Likewise provided is a value document, such as a banknote, a check, a credit or other payment card, an identity card or the like, having the optically variable security element described. It will be apparent that the value document can be modified in the same ways, as already described, as the optically variable security element. Here it is equally possible to apply the described dielectric layer directly to the value document or to the substrate body of the value document.

Likewise provided is a method for producing an optically variable security element in one of the embodiments described above. A substrate body having a front side and a back side is provided and a dielectric layer is applied to the front side of the substrate body, and a structure for a micromirror arrangement comprising first micromirror facets and second, different micromirror facets is introduced into the dielectric layer. In addition, a reflective layer is applied to the structure, and so the reflective layer and the structure in combination form the micromirror arrangement. The first micromirror facets have a smooth surface shape or a curved surface shape that has a focusing effect in the viewer plane, and the second micromirror facets have a curved surface shape that has a light-scattering effect rather than a focusing effect.

It will be apparent that the method of producing the optically variable security element can be modified in the same ways as already described as the optically variable security element and the document of value.

An original of the structures described is produced preferably by lithographic methods, in particular with a laser writer. Alternatively, equipment based on 2-photon absorption is also an option. Electron beam lithography is likewise suitable as a production method, especially for the production of structures in which the micromirror facets have nanostructures or holographic/diffractive structures superimposed on them. After the development of the photoresist, the exposed originals are copied to form a mechanically stable die using electroplating or using photopolymers (e.g., Ormocers). In the mass production application, a multiple arrangement of the original structure by hot stamping or by nanoimprint on a die is required in order to produce an embossing cylinder for later reproduction. Such embossing cylinders ultimately allow the continuous reproduction of the original structure in UV varnish or hot stamping on foils in a roll-to-roll process. Hot stamping or nano-casting in UV varnish is a suitable modeling method.

The embossing structure represents a microfacet arrangement and is subsequently vapor-coated with metal. The common vapor deposition methods are electron beam deposition, sputtering or thermal vaporization. Metals particularly suitable are Al, Ag, Au, Ni, Fe, Cu, W or Cr, and alloys of these metals. If a multilayer coating is applied, the dielectric spacer layer is subsequently applied by vapor deposition. As materials for the dielectric spacer layer, SiO₂, MgF₂, Ta₂O₅, TiO₂, Al₂O₃, MgO, HfO₂, or ZnO can be used. Polymers or inorganic coatings can likewise be used, as can materials combinations and high molecular mass polymers. Equally, of course, the same materials can also be used for the dielectric layer. Instead of a metal layer, a high-refractive-index coating can also be employed for the reflective layer. Suitable for this purpose are the materials ZnS, Ta₂O₅, ZnO, TiO₂ or organic materials, or nanocomposites. Finally, the metallized surface is preferably coated with a transparent outer layer. However, the outer layer can also be applied with a translucent color.

Furthermore, it is possible to assemble an original from different masters with accurate positioning using, for example, nanoimprint methods. This method is particularly suitable for combination of these structures with other known structures such as relief holograms or nanostructures. The micromirror arrangements described, which have nanostructures or a scattering holographic structure superimposed thereon, can also be produced in a single photolithographic exposure process, in particular with e-beam equipment, by means of a grayscale exposure process, or with equipment based on 2-photon absorption.

It will be appreciated that the abovementioned features and those still to be elucidated below may be used not only in the specified combinations but also in different combinations or on their own without departing from the scope of the present invention.

### BRIEF DESCRIPTION OF THE DRAWINGS

The invention is elucidated in greater detail hereinafter by working examples with reference to the accompanying drawings, which likewise disclose features essential to the invention. These working examples serve merely for illustration and should not be interpreted in a limiting manner. By way of example, a description of a working example with a multiplicity of elements or components should not be interpreted to the effect that all these elements or components are necessary for implementation. Instead, other working examples may also contain alternative elements and components, fewer elements or components, or additional elements or components. Elements or components of different working examples can be combined with one another, unless stated otherwise. Modifications and alterations described for one of the working examples may also be applicable to other working examples. In order to avoid repetitions, elements that are identical or correspond to one another in different figures are designated by identical reference signs and are not explained repeatedly. In the figures,

FIG. 1 shows a first embodiment of a value document in plan view,

FIG. 2 shows a second embodiment of a value document in plan view,

FIG. 3 shows a light beam analysis of a first micromirror arrangement,

FIG. 4 shows a light beam analysis of a second micromirror arrangement,

FIG. 5 shows a light beam analysis of a third micromirror arrangement,

FIG. 6 shows a light beam analysis of a fourth micromirror arrangement,

FIG. 7 shows a security element with a metallized micromirror arrangement in a sectional representation,

FIG. 8 shows the security element with the micromirror arrangement according to FIG. 7, coated with a multilayer coating, in a sectional representation,

FIG. 9 shows the security element with the micromirror arrangement according to FIG. 7, printed with a color-imparting nanostructure, in a sectional representation,

FIG. 10 shows a security element with a metallized micromirror arrangement in a further embodiment, in a sectional representation,

FIG. 11 shows an isometric representation of a micromirror facet in a first embodiment,

FIG. 12 shows an isometric representation of a micromirror facet in a second embodiment,

FIG. 13 shows an isometric representation of a micromirror facet in a third embodiment,

FIG. 14 shows an isometric representation of a micromirror arrangement,

FIG. 15 shows an isometric representation of a micromirror facet with a non-rotationally-symmetrically curved surface in a first embodiment,

FIG. 16 shows an isometric representation of a micromirror facet with a non-rotationally-symmetrically curved surface in a second embodiment,

FIG. 17 shows a scatter distribution of the reflected light from three different surface shapes of micromirror facets along a spatial direction,

FIG. 18 shows a cross section of a micromirror arrangement in the form of a Fresnel structure, and

FIG. 19 shows a top view onto the micromirror arrangement according to FIG. 18 as a vertical profile with micromirror facets drawn in.

Structures that correspond to one another structurally or functionally are each given the same reference sign in the figures.

### DETAILED DESCRIPTION OF VARIOUS EMBODIMENTS

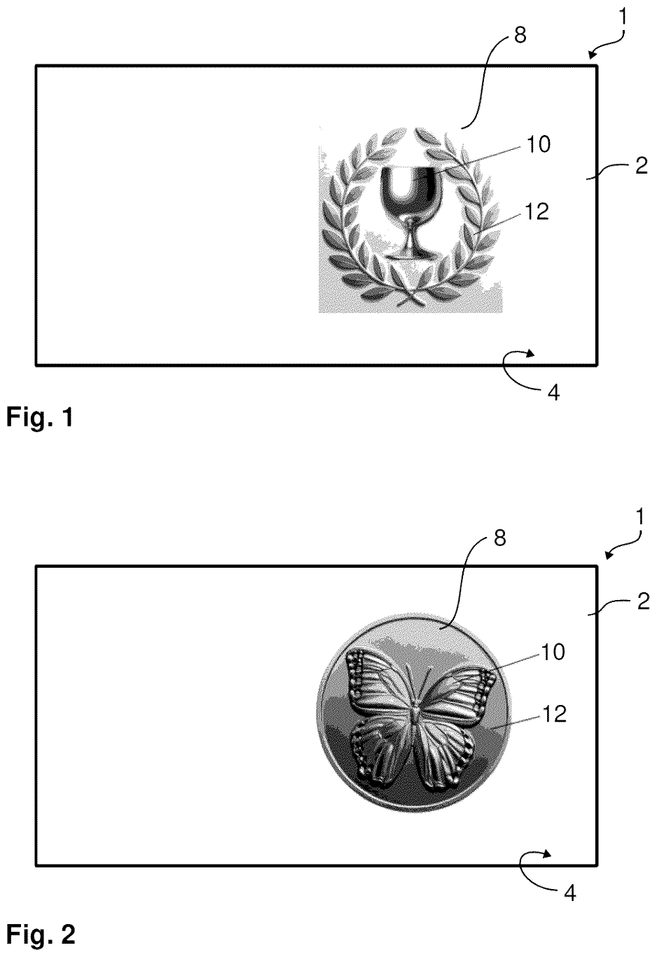

FIG. 1 shows a first embodiment of a value document 1 in plan view. An optically variable security element 8 is applied to a substrate body 2 having a front side 4 and a back side 6. The security element 8 has a glossy region 10 representing a goblet and a matted region 12 representing a laurel wreath.

FIG. 2 shows a second embodiment of the value document 1 in plan view. In this embodiment, the security element 8 represents a colored morpho butterfly for the viewer in the glossy region 10, which appears metallically glossy and stands out from a matted background in the matted region 12.

The substrate body 2 may, for example, be a polymer substrate, such as a PET substrate, but paper substrates or combined paper-polymer substrates are also possible.

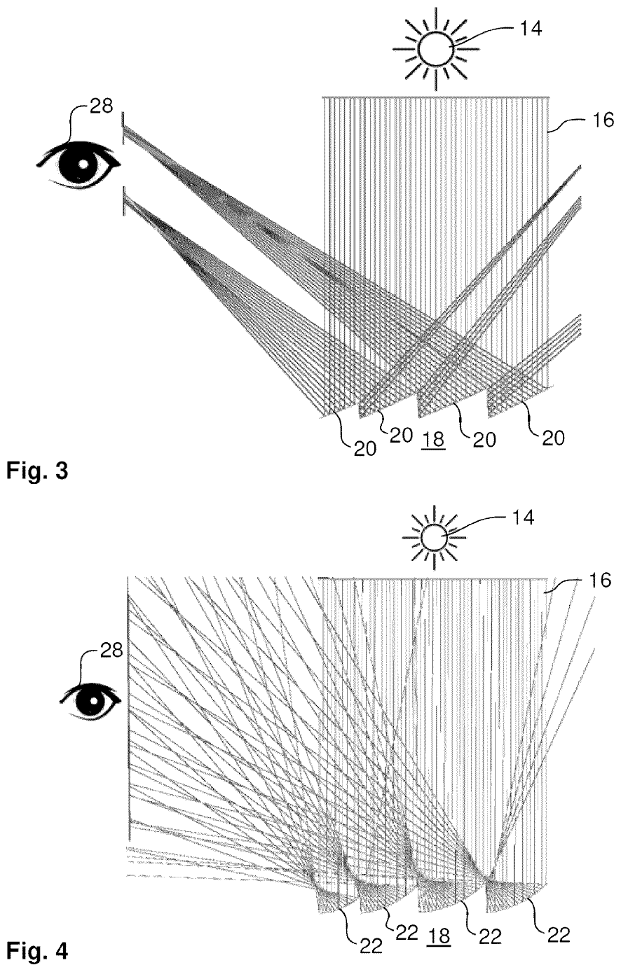

FIGS. 3 to 6 analyze the scattering characteristics of different micromirror arrangements by means of a light beam analysis. A sun 14 is shown as an illustrative illumination source, which, owing to its far distance, emits light rays 16 as a parallel beam onto a micromirror arrangement 18 having first micromirror facets 20 and/or second micromirror facets 22. It is also possible to use less distant illumination sources that emit a parallel beam. The beam path is viewed in FIGS. 3 to 6 for the sake of simplicity only in two dimensions and the second micromirror facets 22 have a curvature of their surface in only one spatial direction; the surface curvatures of the individual second micromirror facets 22 may differ. The external viewer is located at a distance of about 30 cm to 50 cm.

The micromirror arrangement 18 of FIG. 3 has four first micromirror facets 20, from which the light rays 16 are deflected and guided toward or away from an eye 28 of an external viewer. The first micromirror facets 20 of FIG. 3 have a slightly curved surface, and so they show a focusing effect at the distance of the external viewer. The micromirror arrangement 18 appears as a whole as a glossy region 10, since almost all light beams 16 are guided in the direction of the eye 28 of the external viewer and are focused there.

The micromirror arrangement 18 of FIG. 4 comprises four second micromirror facets 22 having a curved surface shape, which scatter incident light rays 16 and thus appear as a matted region 12 at the distance of the external viewer.

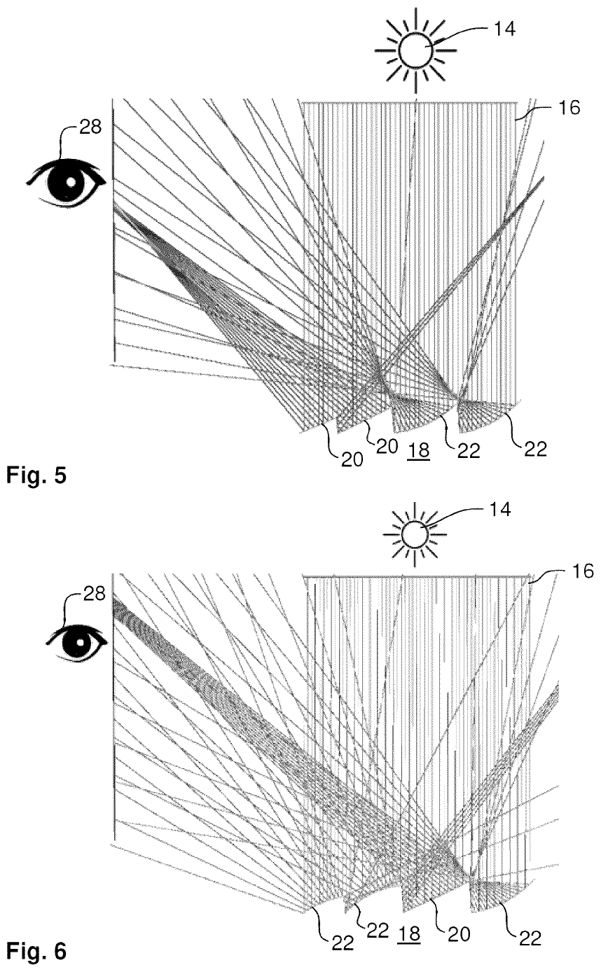

The micromirror arrangement 18 of FIG. 5 comprises two first micromirror facets 20 and two second micromirror facets 22—they have a different scattering effect. The first micromirror facets 20 are configured like the first micromirror facets 20 in FIG. 3 and thus have a focusing effect at the distance of a viewer. The second micromirror facets 22 show a scattering effect, as depicted in FIG. 4 for the second micromirror facets 22—they do not have a focusing effect. The surface of the second micromirror facets 22 is curved and may be spherical or parabolic, for example. In this case, the eye 28 of the external viewer perceives the region in which the first micromirror facets 20 are provided as a glossy region 10, because their surface is planar or slightly curved (focusing). The other region, in which the second micromirror facets 22 are provided, is perceived as a matted region 12, since the surface of the second micromirror facets 22 is curved or arched and thus scatters the incident light rays 16 in a light cone.

The micromirror arrangement 18 of FIG. 6 also has micromirror facets 20, 22 with different scattering effects. A first micromirror facet 20 is arranged between three second micromirror facets 22. The two left-hand second micromirror facets 22 each have a convexly curved surface. The right-hand second micromirror facet 22 has a concavely curved surface. The three second micromirror facets 22 generate a scattering of the light rays 16 and appear to the external viewer as a matted region 12. The first micromirror facet 20, conversely, has a smooth or slightly curved surface and thus reflects the incident light rays 16 almost completely into the eye 28 of the external viewer—this region appears to them as a glossy region 10.

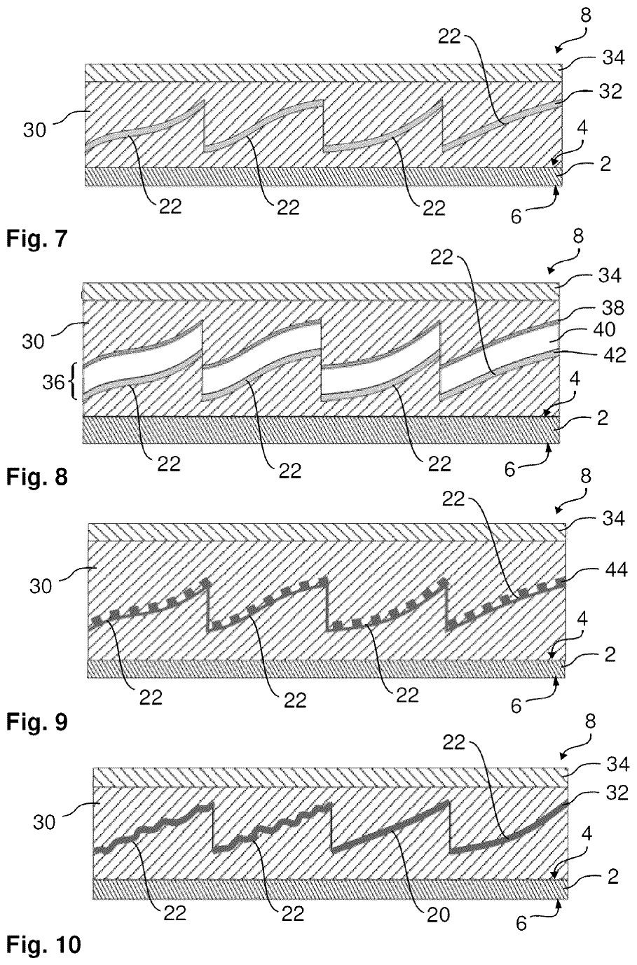

FIGS. 7 to 9 show a security element 8 in a sectional representation. A micromirror arrangement 18 with four second micromirror facets 22 is inserted into a dielectric layer 30, which is located on the front side 4 of a substrate body 2. A transparent protective layer 34 is applied to the dielectric layer 30. Each of FIGS. 7 to 9 depicts the same micromirror arrangement 18, coated differently in each case—in FIG. 7, a metal layer 32 is provided as a reflective layer on the micromirror arrangement 18; in FIG. 8, the micromirror arrangement is coated, instead of the metal layer 32, with a multilayer coating 36 as a reflective layer which has a three-layer construction consisting of a semi-transparent metal layer 38, a dielectric spacer layer 40 and a metallic mirror layer 42; and in FIG. 9, a color-imparting nanostructure 44 is applied to the micromirror arrangement 18 with metal layer 32 located thereon.

The individual second micromirror facets 22 have a laterally varying curvature at their surface in FIGS. 7 to 9, meaning that they have at least one elevation and/or depression in their surface shape. The left-hand micromirror facet 22 has a concave-convex curvature of its surface, the second micromirror facet 22 from the left has a convex-concave curvature of its surface, the next micromirror facet 22 has a concave curvature of its surface, and the right-hand micromirror facet 22 has a convex curvature of its surface. The laterally different surface curvatures of the second micromirror facets 22 that are depicted generate a scatter distribution with a maximum and decreasing intensity in the direction of the limit angles.

FIG. 10 shows a security element with a metallized micromirror arrangement 18 in a different embodiment, in a sectional representation. The two left-hand micromirror facets 22 are finely structured at their surface, with a structure having a multiplicity of elevations and depressions, whereby a mattness can be generated in the reflection. In this exemplary embodiment, a random structure is applied to the surface of the two left-hand second micromirror facets 22. Such a structure is particularly suitable for generating a gaussian scattering angle effect in reflection. The surface of the first micromirror facet 20 is planar and the right-hand second micromirror facet 22 has a concavely curved surface. The micromirror arrangement 18 is coated with the metal layer 32, i.e., metallized.

As can be seen in FIGS. 7 to 10, the micromirror arrangement 18 is embossed into the dielectric layer 30 and preferably embedded directly into it. The protective layer 34, the dielectric layer 30 and the substrate body 2 are in that case more preferably transparent. A color-imparting layer is applied to the micromirror arrangement 18. In the exemplary embodiments of FIGS. 7 to 10, the micromirror arrangement 18 is vapor-coated with a reflective layer. In FIGS. 7, 9 and 10, this reflective layer is the metal layer 32, which in FIG. 9 additionally has the color-imparting nanostructure 44 superimposed thereon. In FIG. 8, the reflective layer is the multilayer coating 36, comprising a layer sequence of semi-transparent metal layer 38, dielectric spacer layer 40 and metallic mirror layer 42—it thus represents a color shift coating.

An effect of a multilayer coating 36 as represented in FIG. 8 is that only a part of the incident light spectrum is reflected and thus the reflection of incident white light appears colored. The hue here depends on the angle of incidence of the light rays 16. By superimposing the color-imparting nanostructure 44 on the reflective layer, both the glossy region 10 and the matted region 12 of a motif can be given different colors, in that lattice parameters of the color-imparting nanostructure 44 are chosen differently according to region. For this purpose, the color-imparting nanostructures 44 can in the simplest case be metallized with a single layer, but it is also possible to apply a multilayer coating, in particular to provide a color shift coating.

Color shift coating of the micromirror arrangement 18 generates a color for the overall motif that changes on tilting or for slanted mirror faces. If color-imparting nanostructures 44 are arranged on the micromirror arrangement 18, profile parameters of the color-imparting nanostructure 44 can be varied laterally, and so laterally different colors are formed, which can change on tilting.

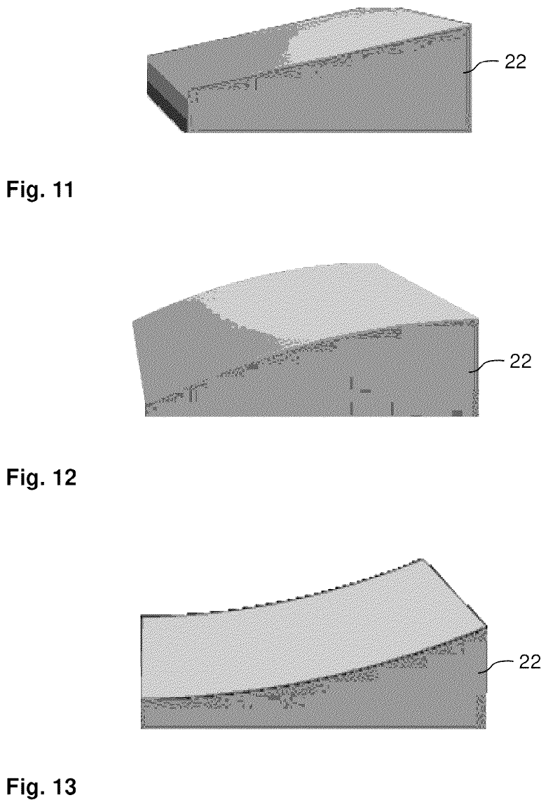

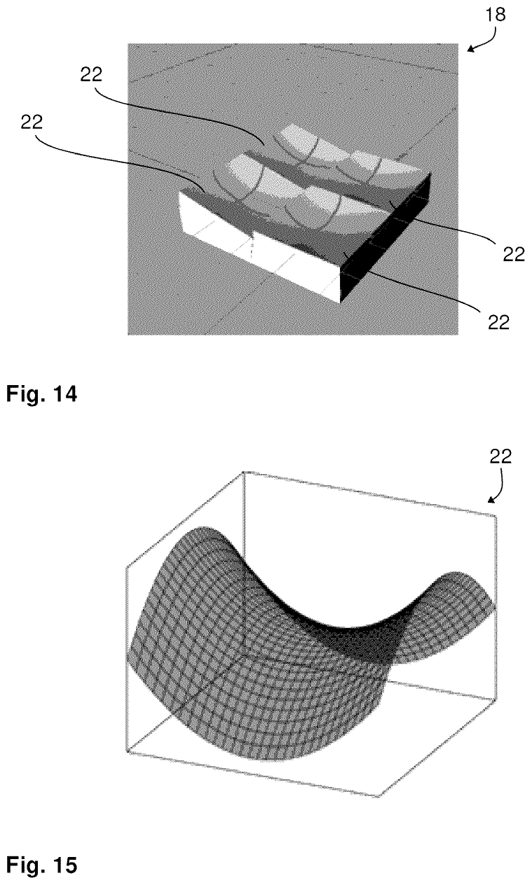

FIGS. 11 to 13 show isometric representations of second micromirror facets 22, which, seen in the vertical profile, have unilaterally declining slope lines along a spatial direction. Such second micromirror facets 22 scatter the incident light rays 16. It is also possible, as shown in FIG. 14, for the surface of the second micromirror facets 22 in a micromirror arrangement 18 to be curved in both spatial directions and then, for example, to have an extreme point—in this case a minimum—in the center, to which, seen in the vertical profile, slope lines run, or, in the converse case of a maximum, from which slope lines run away. In FIG. 14, micromirror facets 22 of a micromirror arrangement 18 are represented schematically in the 3-dimensional space. They have different curvatures. Their surface is concave and can be embodied as rotationally symmetrical, for example, as a collimator—such a form promotes a high intensity component in the glossy regions 10 of a motif.

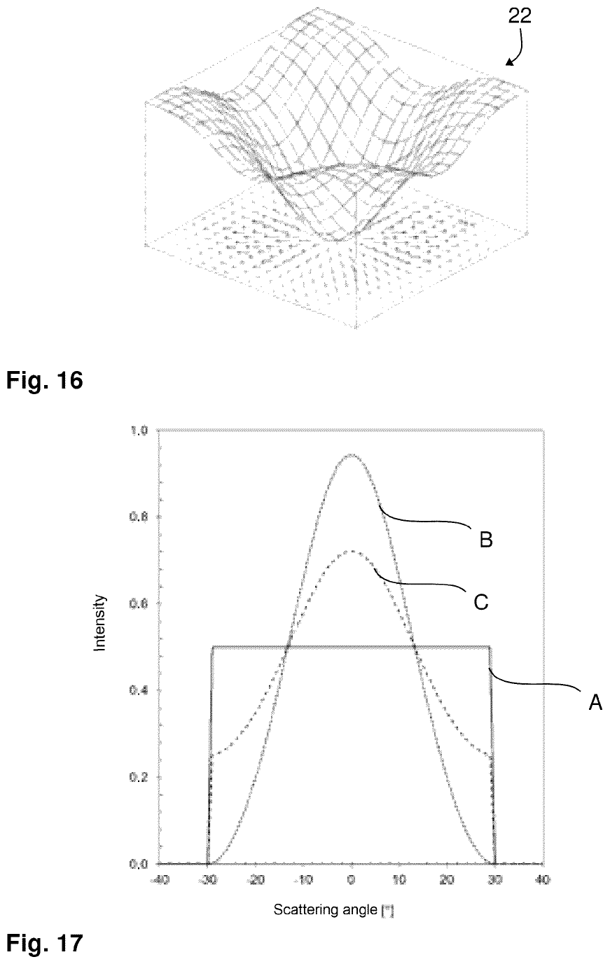

However, it is equally possible too for the second micromirror facets 22 to have curvatures on their surface which are not rotationally symmetrical to their face center, as is represented illustratively in FIGS. 15 and 16. FIG. 15 shows the surface of the second micromirror facet 22 in saddle form, a geometry which is curved concavely in one spatial direction and convexly in the other spatial direction. FIG. 16 shows a surface shape of the second micromirror facet 22 which has a multiple symmetry and possesses a depression in the center. Both surface shapes have a plurality of extreme points at the edges of the surface, from which slope lines run away as seen in the vertical profile. The surface shapes which are depicted in FIGS. 15 and 16 can have a focusing effect in certain spatial directions and a scattering effect in other spatial directions. Depending on the viewing angle, they may represent glossy regions 10 or matted regions 12. It is thus possible with the second micromirror facets 22 to generate a glossy region 10 for one viewing angle and a matted region 12 for a second, different viewing angle.

FIG. 17 compares an intensity on the y-axis with a scattering angle on the x-axis and thus shows a scatter distribution of surfaces of different curvature in a scattering angle range of +/−40° along a spatial direction. In this example, a maximum angle of inclination of the surface of the second micromirror facets 22 is +/−15°. Curve A is the result of a surface shape with uniform curvature that produces a homogeneous scattering angle distribution of the light scattering. Curves B and C are generated by surface shapes that have laterally different curvatures. While not explicitly depicted, it would likewise be possible to generate asymmetric scatter distributions. For example, a random structure causes a scattering fraction to be produced by the light diffraction in the first order of diffraction. This can also be used to generate gaussian scatter distributions, for example.

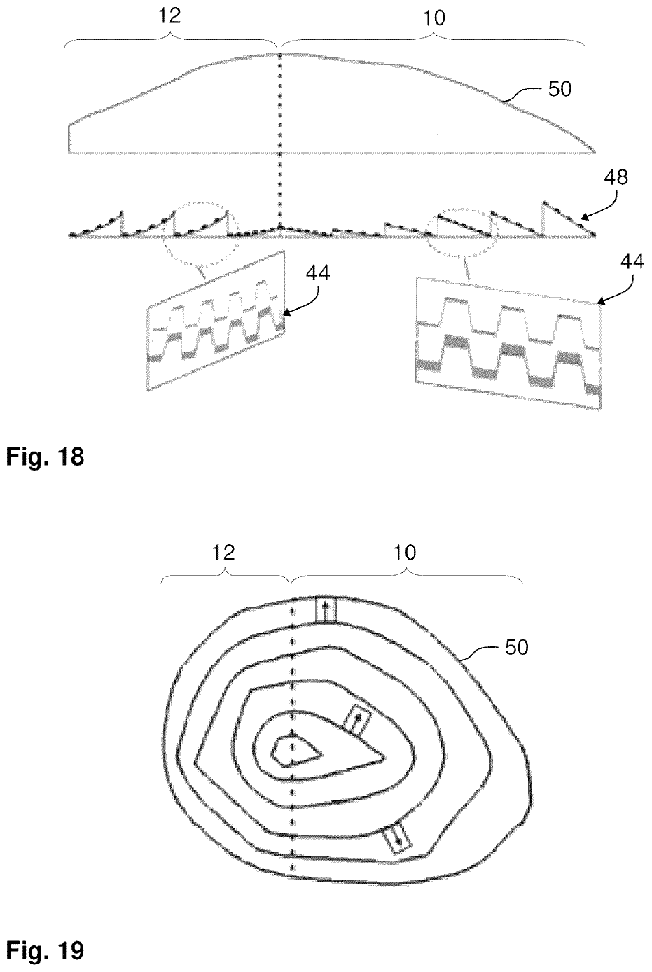

In FIGS. 18 and 19, a micromirror arrangement 18 is depicted which is formed as a Fresnel structure 48. The Fresnel structure 48 has a glossy region 10 and a matted region 12 and generates a three-dimensional appearance. FIG. 18 shows the cross section of this Fresnel structure 48, the surface of which is composed of first micromirror facets 20 and second micromirror facets 22. The first micromirror facets 20 are arranged in the glossy region 10 and the second micromirror facets 22 in the matted region 12, and they are both oriented along a vertical profile 50 of the three-dimensional structure. FIG. 19 shows a top view onto the vertical profile 50.

In this exemplary embodiment, the surfaces of the first micromirror facets 20 are planar in the glossy region 10; the surfaces of the second micromirror facets 22 are concavely curved in the matted region 12. In addition, the first micromirror facets 20 and the second micromirror facets 22 have a color-imparting nanostructure 44 superimposed on them, which is vapor-coated with a trilayer, i.e., with a multilayer coating 36. In this way, motifs can be generated which have spatial or movement effects in reflection. Such motifs may exhibit a change in color on tilting or turning. If such micromirror arrangements 18 have color-imparting nanostructures 44 and/or multilayer coatings 36 superimposed on them, multicolored motifs or true-color images can also be generated. Finally, individual first micromirror facets 20 and/or second micromirror facets 22 can also be specifically colored by motheye structures, so that, for example, portraits, animals or natural objects can be depicted with high contrast. The use of such micromirror arrangements 18 as a security feature increases the anticounterfeit security and the attractiveness of human features.

### LIST OF REFERENCE SIGNS

1 value document
2 substrate body
4 front side
6 back side
8 security element
10 glossy region
12 matted region
14 sun (far distant light source)
16 light rays
18 micromirror arrangement
20 first micromirror facet
22 second micromirror facet
28 eye of an external viewer
30 dielectric layer
32 metal layer
34 protective layer
36 multilayer coating
38 semitransparent metal layer
40 dielectric spacer layer
42 metallic mirror layer
44 color-imparting nanostructure
48 Fresnel structure
50 vertical profile

What is claimed is:

1. An optically variable security element for securing security papers, value documents, value articles or the like, which has:
a substrate body that has a front side and a back side,
a dielectric layer which is applied to the front side of the substrate body and comprises a microfacet arrangement comprising first micromirror facets and second, different micromirror facets, and
a reflective layer which is applied to the microfacet arrangement and thus forms the micromirror arrangement,
wherein
the first micromirror facets have a smooth surface shape or have a curved, focusing surface shape, and
the second micromirror facets have a curved surface shape which has no focusing effect.

2. The security element according to claim 1, wherein the curved surface shape of the first micromirror facets has a focusing effect in a plane 20 cm to 50 cm away from a viewer.

3. The security element according to claim 1, wherein the microfacet arrangement is a Fresnel structure.

4. The security element according to claim 1, wherein the first micromirror facets are arranged in a first region and the second micromirror facets in a second region, where the first region and the second region are directly adjacent to one another or are interspersed with one another.

5. The security element according to claim 1, wherein the surface shape of the second micromirror facets is concavely and/or convexly curved.

6. The security element according to claim 1, wherein the surface shape of the second micromirror facets is spherically or parabolically curved.

7. The security element according to claim 1, wherein the surface shape of the second micromirror facets has at least one elevation and/or at least one depression.

8. The security element according to claim 1, wherein the surface shape of the second micromirror facets has unilaterally declining slope lines.

9. The security element according to claim 1, wherein the surface shape of the second micromirror facets has slope lines running away from at least two extreme points at the edges.

10. The security element according to claim 1, wherein the surface shape of the second micromirror facets has slope lines running toward an extreme point in the center or running away from said point.

11. The security element according to claim 1, wherein the reflective layer is a multilayer coating, more particularly a color shift coating.

12. The security element according to claim 1, wherein the micromirror arrangement has a color-imparting nanostructure superimposed on it at least regionally, where the color-imparting nanostructure comprises at its surface a metal layer or a multilayer coating.

13. The security element according to claim 12, wherein the color-imparting nanostructure is a one-dimensionally periodic nanostructure or a two-dimensionally periodic nanostructure.

14. A value document, such as a banknote, a check, a credit card or other payment card, an identity card or the like, having an optically variable security element according to claim 1.

15. A method for producing an optically variable security element according to claim 1, in which
a substrate body which has a front side and a back side is provided,
a dielectric layer is applied to the front side of the substrate body, where a microfacet arrangement comprising first micromirror facets and second, different micromirror facets is introduced into the dielectric layer, and
a reflective layer is applied to the microfacet arrangement and thus forms the micromirror arrangement,
wherein
the first micromirror facets have a smooth surface shape or have a curved, focusing surface shape, and
the second micromirror facets have a curved surface shape which has no focusing effect.
